(19) United States
(12) Patent Application Publication
(10) Pub. No.: US 2013/0258360 A1
(43) Pub. Date: Oct. 3, 2013

(54) Selection of Colors for an Ensemble of Visible Reference Color Patches

(71) Applicants: Kok-Wei Koh, Mountain View, CA (US); Nathan Moroney, Palo Alto, CA (US)

(72) Inventors: Kok-Wei Koh, Mountain View, CA (US); Nathan Moroney, Palo Alto, CA (US)

(21) Appl. No.: 13/433,488

(22) Filed: Mar. 29, 2012

(51) Int. Cl. H04N 1/60; G09G 5/02

(52) U.S. Cl. 358/1.9; 345/593

(57) ABSTRACT

A method of creating an ensemble of visible color reference patches first adds a set of starting colors to a queue. The process then finds a candidate color within a color selection zone that is furthest away from colors existing in the queue. This candidate color is then selected by placing it in the queue. The steps of finding and selecting are repeated until a target number of selected colors is reached. The process then generates visible color patches of the selected colors for forming the ensemble.

### BACKGROUND

Printed or displayed reference color patches are widely used in various applications for color identification and calibration purposes. For instance, a swatch book with multiple strips of printed color patches of various hues is commonly used by artists or designers to select paint or fabric colors. As another example, a printed color chart with multiple patches of different reference colors may be used in diagnosing and calibrating the color systems of digital cameras and displays. As a further example, color patches of selected reference colors may be displayed on a display screen and measured for calibration purposes. The choice of colors to be includes in the printed or displayed reference color ensemble is important, as it can greatly affect the quality of the calibration and consistency of measurements.

### BRIEF DESCRIPTION OF THE DRAWINGS

FIG. 1 is a diagram showing a schematic view of a color chart with printed reference color patches;

FIG. 2 is a diagram showing a schematic view of a swatch book with strips of printed reference color patches;

FIG. 3 is a diagram showing a schematic view of a color control strip with multiple printed reference color patches;

FIG. 4 is a diagram showing a schematic view of a display device for displaying an ensemble of reference color patches;

FIG. 5 is a schematic diagram showing an example of a color gamut in the CIE L*a*b* color space;

FIG. 6 is a flowchart showing a computer-implemented process according to an embodiment of the invention for selecting colors for use in an ensemble of printed or displayed reference color patches;

FIG. 7A is a schematic diagram illustrating a set of reference colors in a 2D color space selected in a conventional way;

FIG. 7B is a schematic diagram illustrating a set of reference colors in a 2D color space selected by the color selection process of FIG. 6; and

FIG. 8 is a computer system in an embodiment for implementing the process of selecting colors for an ensemble of printed or displayed color reference patches.

### DETAILED DESCRIPTION

In embodiments of the invention described below, a new color selection approach is used for selecting colors to be used in an ensemble of visible reference color patches. As described in detail below, the color selection approach allows additional colors to be easily added to expand the set of reference colors, and can be easily tailored to provide finer resolutions on desired portions of the color gamut.

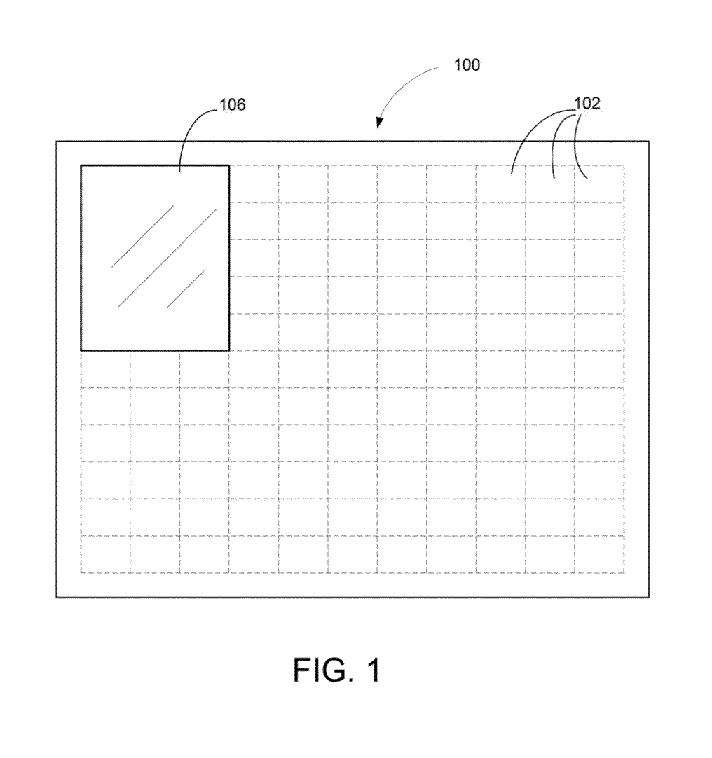

To illustrate the potential applications embodying the colors selected according to the color selection approach, FIG. 1 shows an example of a color chart. The color chart 100 has a plurality of printed color patches 102. As illustrated in FIG. 1, each color patch 102 may be a rectangle printed with a particular color. For ease of illustration, FIG. 1 does not show the actual colors of the patches. The rectangular color patches 102 can be arranged in a grid, as illustrated in FIG. 1, and tens or hundreds of reference color patches can be placed on one color card. The color chart may be an individual sheet, or be combined with other printed materials (e.g., printed in magazines as insert). In the illustrated embodiment, the color card 100 may include a cut-out window 106 in its upper left corner. To compare the colors on the color card 100 with an object (e.g., a painted wall or the body of a car), the card is placed over the object such that the color of the object shows through the window 106. A comparison of the object color can then be made by a user via visual inspection. Alternatively, an image of the color card over the object can be taken with an image capturing device, such as a digital camera or a scanner, and the captured color information can be processed by means of suitable software for comparison, diagnostic and calibration purposes.

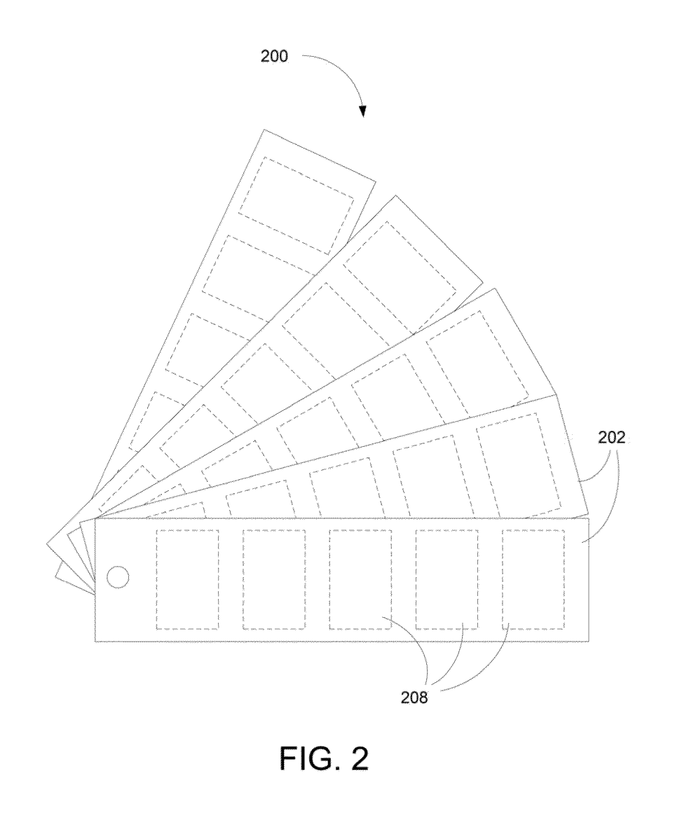

As another example of potential implementation, FIG. 2 shows an example of a swatch book 200. The swatch book has a plurality of strips 202. Each strip 202 has a selected number of printed color patches 208. Each color patch 208 may be different in color from the other patches on the same strip, and the colors on each strip may be different from the colors on the other strips. The color patches on all the strips together form an ensemble of reference colors.

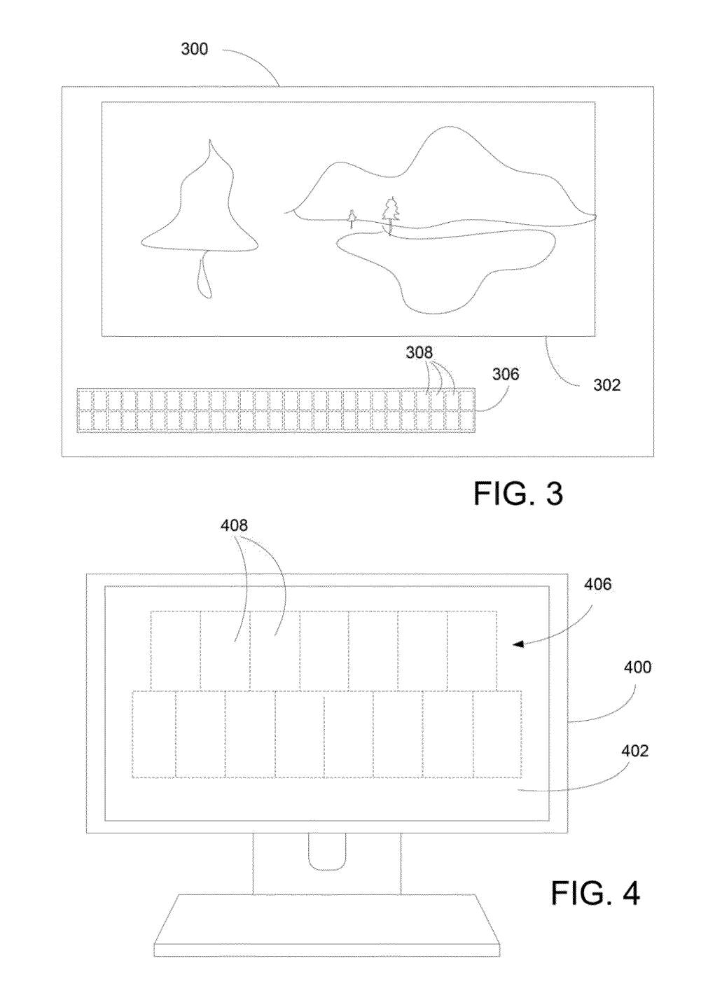

Another form of an ensemble of printed reference color patches is a color control strip, which is often used for color proofing a printed object (e.g., a poster). As illustrated in FIG. 3, a printed object 300 contains a printed image 302. A color control strip 306 is also printed in the same object and adjacent the image 302 (e.g., near the margin of a sheet). The color control strip 306 includes multiple reference color patches 308. The color patches 308 may be arranges in rows, similar to the format of the commonly used Ugra/Fogra Media Wedge CMYK v.3.0 or IDEAlliance ISO 12647.7 Color Control Strip.

Instead of being printed, visible reference color patches may also be in a displayed form. For instance, reference color patches can be displayed on a display screen of a computer monitor, a screen of a mobile device, etc. FIG. 4 illustrates such an example. As shown in FIG. 4, a color ensemble 406 includes multiple color patches 408 with colors corresponding to a selection of RGB reference colors. The color patches 408 are displayed on the screen 402 of a monitor 400, and the displayed colors can be measured with a colorimeter or spectrophotometer and used to create an ICC profile for that particular monitor.

As mentioned above, an ensemble of printed or displayed reference colors can be used for color comparison, diagnostic, and calibration purposes. To that end, it is desirable to select the reference colors to effectively represent a zone of color space that is of interest, which may be the entire color gamut or a selected portion of the color gamut. Moreover, it is desirable to have the design freedom to include some particular color of interest, or to adjust the number of colors in the ensemble to suit the needs of the applications.

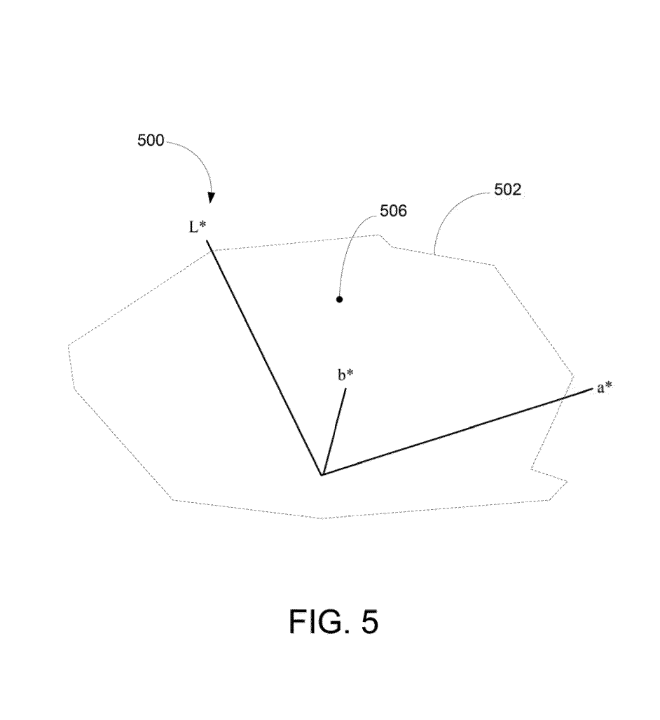

By way of example, FIG. 5 shows a color gamut 502 presented in the CIE L*a*b* color space 500, wherein a particular color 506 is represented by a point in the gamut. The color gamut 502 may be related to a given physical device, such as a printer, and the size and shape of the color gamut may depend on the characteristics of that device. For instance, the color gamut 502 may be for a color printer that uses inks of 8 different colors for printing. lithe ensemble of reference colors is intended for applications that involve the entire color gamut, than the reference colors will be selected from the entire color gamut. On the other hand, if the color ensemble is intended for a particular portion of the color gamut, such as a blue zone of the gamut, then the reference colors can be selected from that particular portion.

In embodiments of the invention, the color selection is done in a way that is drastically different from the conventional ways of selecting reference colors. As described below, rather than picking colors that are evenly spaced in the color space, the color selection under the approach of embodiments of the invention tends to result in colors that are irregularly spaced. By removing the constraint of having evenly spaced colors, the current approach can create a rich set of colors that may be better suited for the particular application, and the number of colors that can be selected is flexible.

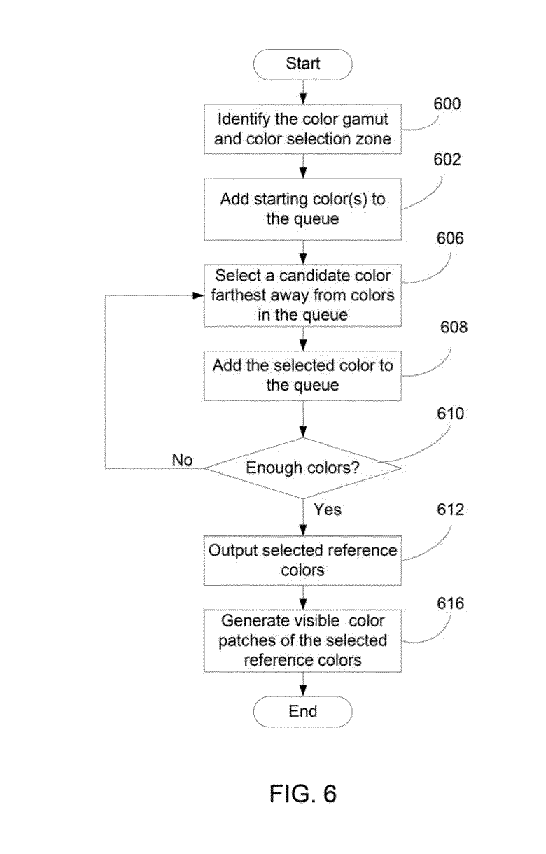

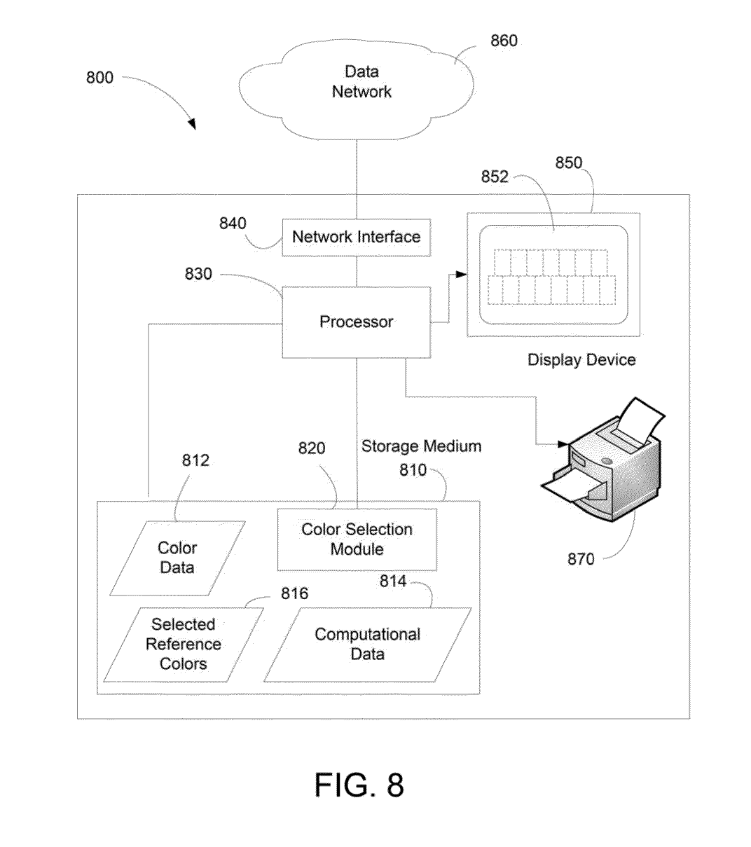

FIG. 6 shows a computer-implemented process for selecting the reference colors. As described later with reference to FIG. 8, the process may be carried out by a color selection module. The color selection process starts with defining the color space to be used and also the zone (the “color selection zone”) of the color space from which the colors will be selected (step 600). For instance, for printing-related applications, it may be common to use the CIE L*a*b* color space. Nevertheless, depending on the intended applications, other color spaces may be used. If the set of reference colors is intended to be a good representation of the color gamut, then the entire color gamut may be involved in the selection process. If, however, the reference colors are for an application that involves only a portion of the color gamut, then the color selection may choose colors only from within that portion.

During the computer implemented selection process, the selected colors are placed in a queue. At the beginning of the process, the queue may be first populated with one or more starting colors (step 602). The selection of the starting colors is flexible. For example, the starting colors may be black or white, or several gray scale colors in addition to black and white. The starting colors may also include a set of particular colors. For instance, if the color gamut is for an eight-color printer that prints with cyan, magenta, yellow, red, green, blue, black, white, then these primary and secondary colors can be selected as the starting colors. The starting colors may be designated by the user. Alternatively, the color selection may select its own starting color or colors. For instance, the color selection module may pick one or more starting colors by using a random number generator.

After the starting color or colors are selected and placed in the queue, the color selection process continues by selecting the next color from the color selection zone. This next color is chosen such that its distance from the colors already in the queue is the greatest among all colors available for selection (step 606). In this regard, the set of colors available for selection would depend on the particular implementation of the embodiment. In one embodiment, any color within the color selection zone may be available. Thus, there may an infinite number of available colors. In this case, the color selection module may choose the next color to put in the queue by means of mathematical calculations to identify a color that has the greatest distance from all existing colors in the queue.

In another embodiment, there is a finite number of available colors, and such colors may be pre-determined before the selection process begins. For instance, the set of available numbers for selection may be taken from the device ICC profile for a device for which the reference color ensemble is generated. Alternatively, as another example of providing the set of candidate colors, the available colors may be taken from a densely sampled table of candidate color patches printed on an output device which will be used to print the reference color ensemble. Given a set of available colors for selection, the color selection module searches through the set and compares each candidate color to the existing colors in the queue, and record the distance (deltaE) of the candidate color to the nearest color in the queue. The candidate color with the largest distance can then be identified by comparing the recorded distances.

The concept of “farthest away” may also be implemented in different ways. In some embodiments, as described above, “farthest away” from the existing colors may be implemented as finding the largest distance from a nearest neighbor. In some other embodiments, for example, “farthest away” may mean find a largest average distance from multiple nearest neighbors.

Once the candidate color that is “farthest away” from the existing colors in the queue is identified, the color selection module adds that color to the queue (step 608). If the desired number of colors in the queue is not reached yet (step 610), the color selection module continues to select the next color by means of the “farthest away” criterion. This selection operation is repeated until the desired number of reference colors is reached. The color selection module then outputs the list of selected colors (step 612). The list of selected reference colors is then used to generate visible color patches with corresponding colors in a desired format (step 616). The ensemble visible color patches may be in a printed form, such as a color chart or strips of color patches for a swatch book, or a color control strip for color Proofing. The visible color patched may also be in a displayed form, e.g., being displayed on the screen of a monitor or a mobile device. Prior to printing or displaying, the selected reference colors may be sorted and reordered to adjust the relative locations of the color patches. For instance, if the final format of the reference color ensemble is a color chart, the selected reference colors may be sorted by hue so that approximately like colors are clustered together on the color chart.

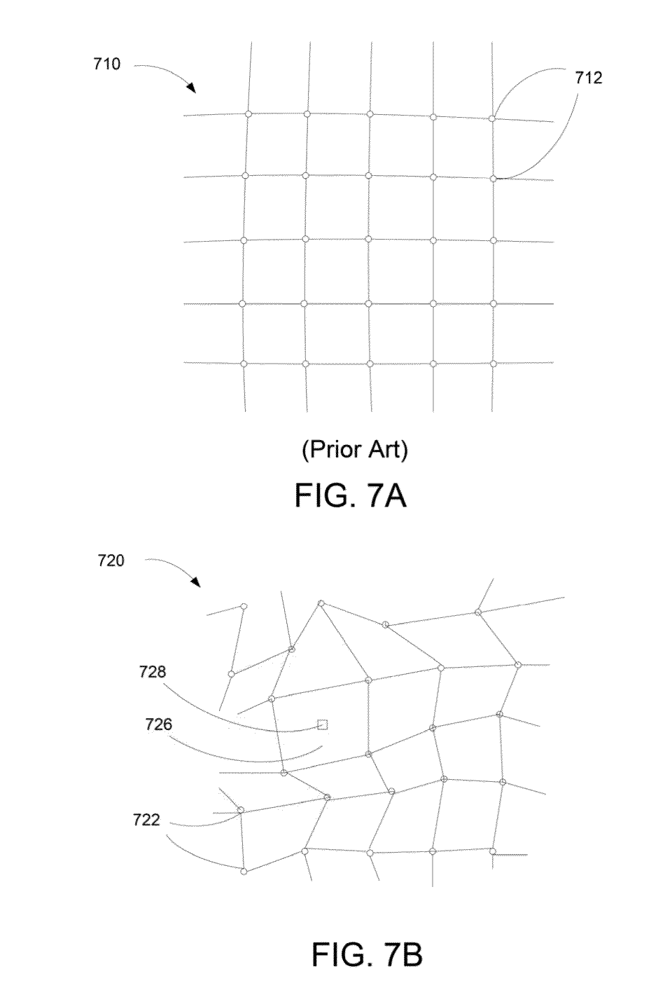

FIGS. 7A and 7B illustrate the concept of the “farthest away” selection criterion, and how it differs from the conventional approach to selecting reference colors. For ease of illustration, the illustrations are done in a 2-dimensional color space. It should be noted, however, that the “farthest away” color selection approach can be used in color spaces of different dimensions, e.g., the 3D CIE L*a*b* space. FIG. 7A illustrates the conventional approach, which picks evenly spaced colors. In this illustration, each selected color 712 is represented as a dot, and the selected colors are linked to its nearest neighbors to show their positional relationship in the color space. It can be seen that under the conventional approach the set 710 of reference colors is selected such that the selected colors are fairly evenly spaced in the color space and form a grid like structure.

In contrast, as illustrated in FIG. 7B, the current approach of selecting reference colors generates a set 720 of reference colors that do not fall onto an evenly spaced grid. Rather, the selected colors 722 (represented by dots) are irregularly spaced, with different distances from their neighbors. This is the result of the selection operation based on the “farthest away” criterion. This criterion can be visualized as a way to fill a void in the color space by adding a new color. As shown in FIG. 7B, at one point of the color selection process, the already selected colors 722 in the selection queue define a void 726 that is currently the largest one in the color selection zone. This void 726 is then filled by adding the color 728 (represented by a square), which is selected based on the “farthest away” criterion. Thus, the color selection process can be viewed as a process of continuously filing the largest voids in the color selection zone until the desired number of selected colors is reached. In this regard, it can be seen that this color selection process has the flexibility of selecting any given number of colors. It is also easy to add more colors to an existing selected color set. All it takes is to continue the void filling operation until the new color number is reached.

FIG. 8 shows a computer system 800 for implementing the color selection technique described above. The system 800 includes a data storage medium 810 which may be used to store color data 812 needed for the color selection operation. The data may include information about the color space, data regarding the color gamut, data defining the color selection zone within the color gamut, and data regarding the list of available colors that can be selected as the reference colors. The storage medium 810 may also be used to store computational data 814 used in the color selection operation, such as the color selection queue. The data 816 representing the final list of selected reference colors may also be stored on the data storage medium. The storage medium 810 is non-transitory and can be implemented as one or more computer-readable or machine-readable storage devices, including DRAMS, SRAMS, flash drives, hard drives, optical storage devices, etc.

The system 800 includes a color selection module 820 for performance the analytic operations on the graph to be studied. The color selection module 820 can be implemented as machine-readable instructions that are executable on a processor 830 of the system. The machine readable instructions may be stored on the storage medium 810. Alternatively, the color selection module 820 may be stored in a separate non-transitory storage device: The system 800 may include a network interface 840 for communicating with a data network 860. The system may also include a display device 850 with a display screen 852, which can be used to display images and data, to assist a user in controlling and monitoring the color selection operation: The display device 850 may also display the ensemble of selected reference colors, if the color patches are to be generated in a displayed form in the intended applications. The system 800 may further include a printer 870, which may be used to print color patches corresponding to the colors selected by the color selection module 820, if the reference color patches are to be in a printed form for use in the intended applications.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method of creating an ensemble of visible color reference patches, comprising:
adding a set of starting colors to a queue;
finding a candidate color with a color selection zone that is furthest away from colors existing in the queue;
selecting the candidate color by placing the candidate color in the queue;
repeating the steps of finding and selecting until a target number of selected colors is reached;
outputting the selected colors; and
generating visible color patches corresponding to the selected colors for forming the ensemble of visible color reference patches.

2. A method as in claim 1, wherein the color selection zone is a color gamut of a device or a portion of the color gamut of the device.

3. A method as in claim 1, wherein the step of generating prints color patches corresponding to the selected colors.

4. A method as in claim 3, wherein the ensemble is in a form of a printed color card, a swatch book, or a color control strip.

5. A method as in claim 2, wherein the step of generating displays color patches corresponding to the selected colors on a display device.

6. A method as in claim 1, wherein the candidate color in the step of finding is from a finite list of selectable colors.

7. A method as in claim 1, wherein the step of finding finds a candidate, color that has a largest distance from a nearest color in the queue.

8. A system for creating an ensemble of visible color reference patches, comprising:
a color selection module programmed to select a list of reference colors by:
adding a set of starting colors to a queue;
finding a candidate color within a color selection zone that is furthest away from colors existing in the queue;
selecting the candidate color by placing the candidate color in the queue;
repeating the step of finding and selecting until a target number of selected colors is reached;
outputting colors in the queue as the list of reference colors; and
a device for generating visible color patches corresponding to the list of reference colors for forming the ensemble of visible color reference patches.

9. A. system as in claim 8, wherein the color selection zone is a color gamut of a device or a portion of the color gamut of the device.

10. A system as in claim 8, wherein the device for generating is a printer

11. A system as in claim 10, wherein the ensemble is in a form of a color card, a swatch book, or a color control strip.

12. A system as in claim 8, wherein the device for generating is a display device for displaying visible color patches corresponding to the list of reference colors.

13. A system as in claim 8, wherein the candidate color is from a finite list of selectable colors within the color selection zone.

14. A system as in claim 8, wherein the color selection module in the finding step finds a candidate color that has a largest distance from a nearest color in the queue.

15. An ensemble of printed reference colors, comprising:
a plurality of printed color patches, wherein colors of the printed color patches correspond to a list of reference colors selected from a color selection zone in a color space based on a void-filling color selection process.

16. An ensemble of printed reference colors as in claim 15, wherein the ensemble is in a form of a color card, a swatch book, or a color control strip.
